(19) United States
(12) Patent Application Publication
(10) Pub. No.: US 2026/0283167 A1
(43) Pub. Date: Sep. 24, 2026

(54) SELECTING DEVICE FOR PIECES OF PROCESSED MEAT, METHOD FOR SELECTING PIECES OF PROCESSED MEAT AND PLANT FOR SLICING PIECES OF PROCESSED MEAT PROVIDED WITH THIS SELECTING DEVICE

(71) Applicant: VE.MA.C. SOCIETA' A RESPONSABILITA' LIMITATA, Castelnuovo Rangone (MO) (IT)

(72) Inventor: Maurizio COSTANTINI

(73) Assignee: VE.MA.C. SOCIETA' A RESPONSABILITA' LIMITATA, Castelnuovo Rangone (MO) (IT)

(21) Appl. No.: 19/475,868

(22) PCT Filed: Apr. 16, 2024
(86) PCT No.: PCT/IB2024/053700

§ 371 Date: Oct. 16, 2025

(30) Foreign Application Priority Data
Apr. 18, 2023 (IT) 102023000007572

(51) Int. Cl. A22C 17/00; A22C 18/00

(52) U.S. Cl. CPC A22C 17/0093; A22C 17/0033; A22C 18/00

(57) ABSTRACT

A selecting device, for selecting from a plurality of pieces of meat groups of pieces of meat the lengths of which differ from one another by an amount that is not greater than a set amount AL, includes a fixed frame and a movable frame that can slide inside the fixed frame, wherein the movable frame is provided with a plurality of shelves each of which is designed to receive a piece of meat, a first pushing element designed to push on a shelf of the movable frame a piece of meat conveyed by a first conveying device, a second pushing element designed to push a piece of meat, placed on a shelf of the movable frame, outside the shelf.

### BACKGROUND OF THE INVENTION

The present invention relates to the meat-processing industry, in particular to the industry processing meat in pieces, where processed meat means, for example, ham, bacon, lard, sausages, and salami in general.

### PRIOR ART

Processed meat in pieces, hereinafter more briefly meat, possibly subjected to seasoning, has to be sliced to prepare packages of sliced meat for sale.

Before being sliced, the pieces of meat are frozen and are then sent to a high-speed industrial slicing machine.

Industrial slicing machines are normally set up to slice in parallel groups of pieces of meat, consisting of two or more pieces of meat. This causes a problem, which depends on the fact that the dimensions of the pieces of meat, in particular the length of the pieces, have great variability.

The great variability results in great waste, that, for each group of pieces of sliced meat corresponds to pieces of meat of a length equal to the difference between the length of the shorter piece of meat and the lengths of the other pieces of meat.

The greater the variability of the length of the pieces, the greater the waste in the slicing operation, with resulting financial loss.

### SUMMARY OF THE INVENTION

One object of the present invention is to remedy the aforesaid problem by minimizing the waste in the meat-slicing operation.

A further object is to provide a device that can form groups of pieces of meat so as to minimize the difference in length between the pieces of meat of a group, wherein the groups have to be formed as simply and rapidly as possible.

A still further object is to provide a method for forming groups of pieces of meat so as to minimize the difference in length between the pieces of each group, wherein the groups have to be formed as simply and rapidly as possible.

The above objects are achieved by a selecting device for forming groups of pieces of meat according to claim 1, by a method for forming groups of pieces of meat according to claim 9 and by a plant for slicing pieces of meat according to claim 15.

Owing to the invention, it is possible to select, from a plurality of pieces of meat to be sent to a slicing machine, groups of pieces of meat in which the difference in length between the longest piece of meat and the shortest piece of meat in each group does not exceed a set value, which is chosen to minimize waste in the slicing operation, thus optimizing said operation, with a significant cost saving.

The groups of pieces of meat are formed simply and rapidly, without lowering the productivity of the slicing process.

### SHORT DESCRIPTION OF THE DRAWINGS

Further features and advantages of the invention will be clear from the following description of an embodiment of the invention, provided merely by way of non-limiting example, with reference to the attached drawings, in which:

FIG. 1 is a plan view of a plant for slicing pieces of meat which includes a selecting device for forming groups of pieces of meat, according to the invention;

FIG. 2 is an elevation view from the left of the plant of FIG. 1;

FIG. 3 is a perspective view of the selecting device for forming groups of pieces of meat, according to the invention;

FIG. 4 is another perspective view of the selecting device, rotated by 90° clockwise, with respect to the perspective view of FIG. 3;

FIG. 5 is a further perspective view of the selecting device, rotated by 180°, with respect to the perspective view of FIG. 3;

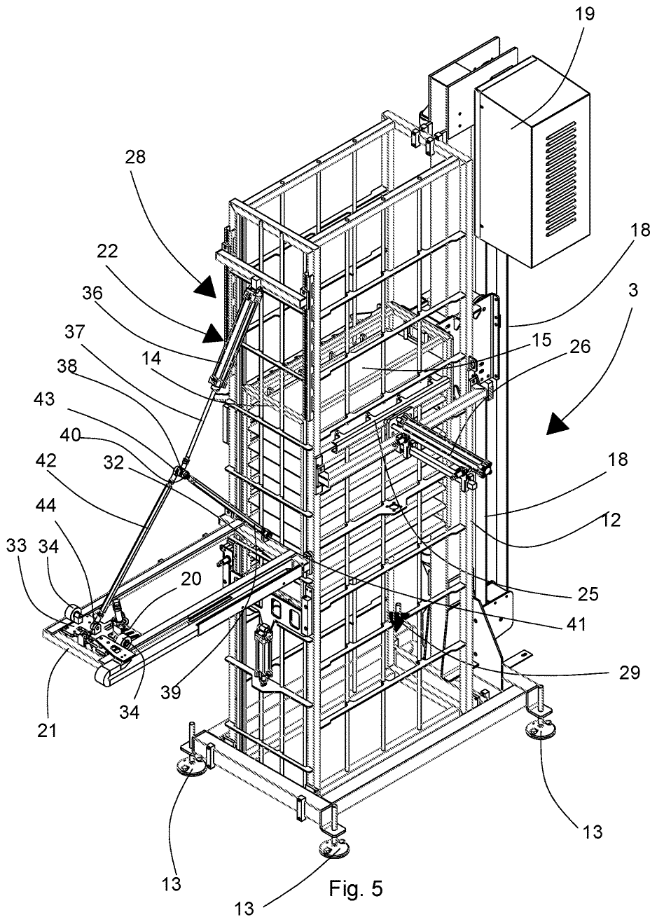

FIG. 6 is an elevation perspective view of a press of the plant of FIG. 1, for pressing the pieces of meat and measuring the length thereof;

FIG. 7 is a further perspective view of the press of FIG. 6;

FIG. 8 is an elevation side view of the press of FIGS. 6 and 7;

FIG. 9 is an enlarged detail of the press of FIGS. 6 to 8.

### DETAILED DESCRIPTION OF THE INVENTION

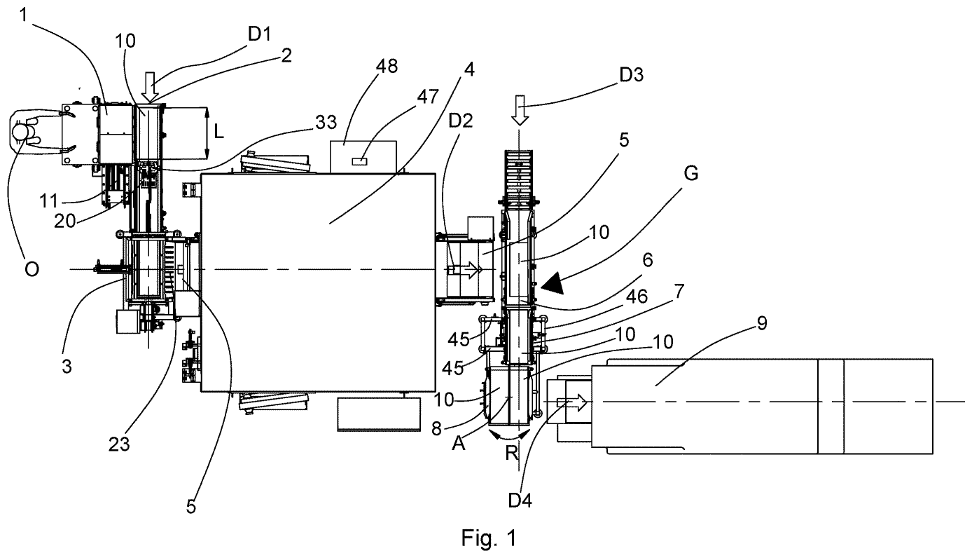

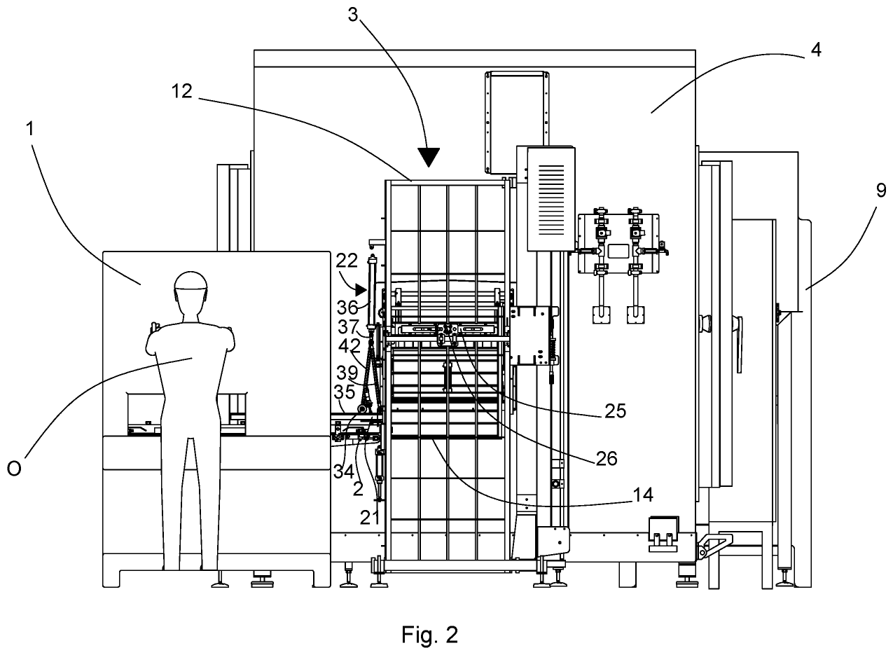

With reference to FIGS. 1 and 2, a plant according to the invention for slicing pieces of meat 10 includes a press 1, in which an operator O inserts pieces of meat.

The press 1 is configured to press the pieces of meat 10 so as to give the pieces of meat 10 a substantially rectangular plan shape with a substantially constant width and thickness.

Further, the press 1 is provided with a measuring device 11, by means of which the length of the pieces of meat subjected to pressing is measured.

The measuring device can also be associated with a first conveyor 2, for example a belt conveyor, on which the pressed pieces of meat 10 are placed.

The first conveyor 2 conveys the pressed pieces of meat 10 along a first direction D1, to a selecting device 3 according to the invention, which selects, as will be explained below, groups G of pieces of meat 10 in which the difference between the length of longest the piece of meat and the length of the shortest piece of meat does not exceed a set amount, which is chosen so as to minimize waste, in a subsequent procedure of slicing the pieces of meat 10.

The pieces of meat 10 of each group G selected by the selecting device 3 are sent in succession, by a second conveyor 5, for example a second belt conveyor, to a cooling tunnel 4, in which the pieces of meat 10 are cooled, so that at least the surface layer thereof acquires sufficient hardness to permit slicing thereof in a high speed industrial slicing machine.

The second conveyor 5 moves, for example, in an advancement direction D2, substantially perpendicular to the first advancement direction D1 of the first belt conveyor 2.

Exiting the cooling tunnel 4, the second conveyor 5 deposits the pieces of meat 10 on a third conveyor 6, for example a third belt conveyor, which moves, for example, in an advancement direction D3, substantially parallel to the first advancement direction D1 of the first conveyor 2.

The third conveyor 6 conveys the pieces of meat 10 onto a fourth conveyor 7, for example a belt conveyor that, in addition to conveying the pieces of meat 10 in the advancement direction D3, can move in a direction perpendicular to D3, along sliding guides 45, obtained on a further support frame 46.

The fourth conveyor 7 conveys the pieces of meat 10 on a fifth conveyor 8, so as to form on said fifth conveyor 8 groups G of pieces of meat 10, having a set number k of pieces of meat 10.

The fifth conveyor 8 can rotate around a rotation axis A perpendicular to the conveying plane thereof, so as to orient the pieces of meat 10 with the respective larger sides parallel to a direction substantially perpendicular to the advancement direction D3 of the third belt conveyor 6 and of the fourth belt conveyor 7.

The groups G of pieces of meat 10 are finally conveyed by the fifth conveyor 8 to a slicing machine 9, for example a high-speed slicing machine, which slices the groups of pieces of meat 10 and sends the thus obtained slices to a packaging device that is not shown.

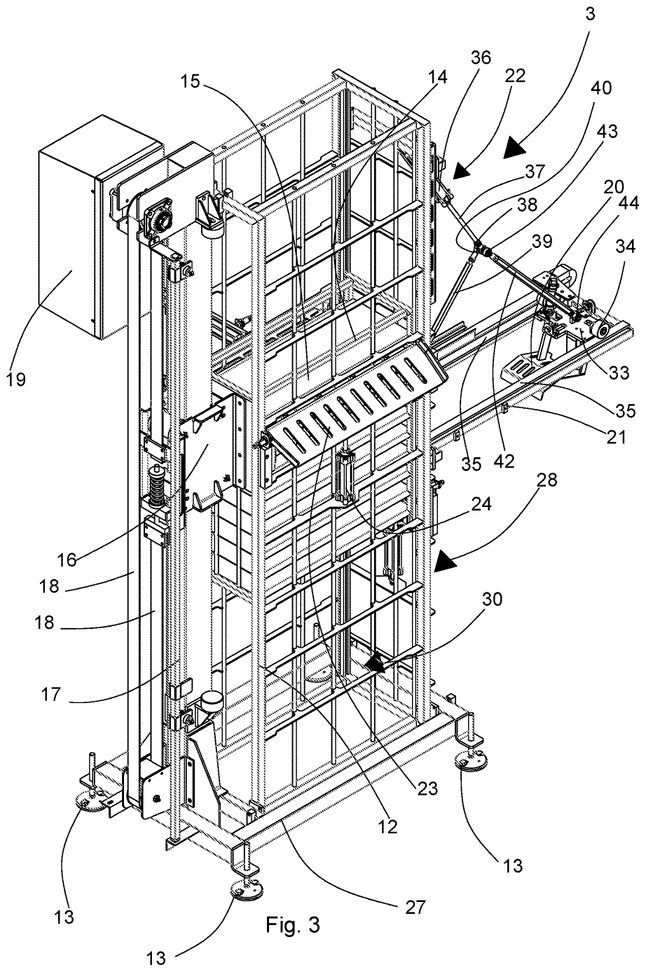

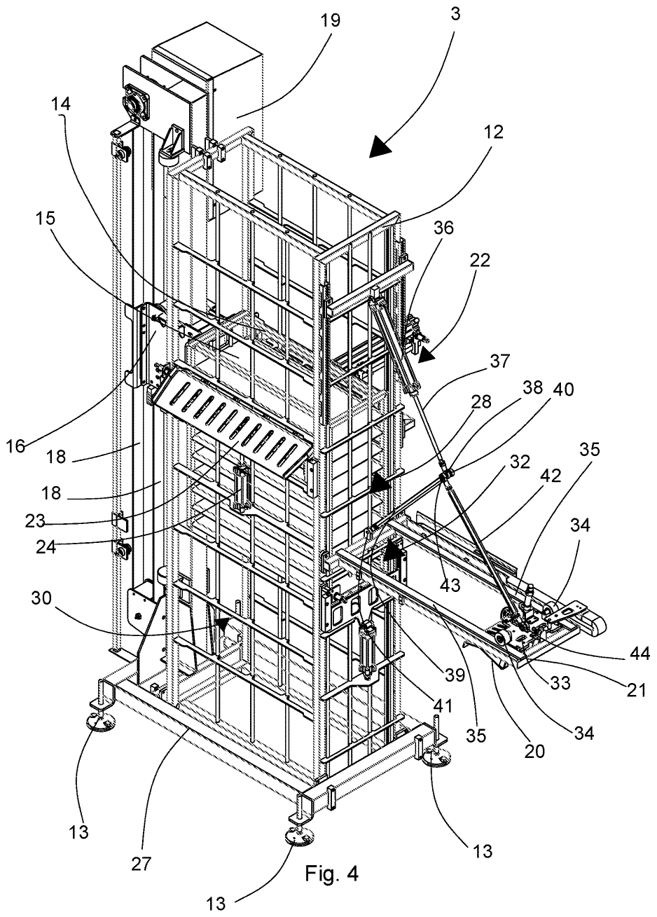

In FIGS. 3 and 4, the selecting device 3 according to the invention is illustrated.

The selecting device 3 includes a fixed frame 12, which is fixed to a base 27, provided with feet 13 for resting on the ground. The fixed frame 12 extends in a vertical direction substantially perpendicular to the base 27.

The term “vertical direction” means a direction parallel to the direction of the force of gravity.

Inside the fixed frame, a movable frame 14 is arranged provided with a plurality of superimposed shelves 15 each of which is designed to receive a piece of meat 10.

The movable frame 14 is connected to a slide 16, that can slide in said vertical direction, along a sliding guide 17, fixed to the base 27.

The slide 16 is driven to move along the sliding guide 17 by a motor 19, via a transmission 18, for example a belt transmission.

On a first side 28 of the fixed frame 12 facing the first belt conveyor 2, a first pushing element 20 is arranged the function of which is to push the pieces of meat 10 arriving along the first conveyor 2 onto the shelves 15 of the movable frame 14.

The first pushing element 20 is associated with a support frame 21, fixed to the fixed frame 12 of the selecting device 3, in an inlet zone 32 of the selecting device 3.

The support frame 21 extends from the fixed frame 12 in a horizontal direction, perpendicular to said vertical direction, i.e. perpendicular to the direction of the force of gravity.

The support frame 21 is arranged above the first conveyor 2, at a distance therefrom that is such as to enable the first pushing element 20 to come into contact with a piece of meat 10 arriving on the conveyor 2 and push the piece of meat 10 onto one of the shelves 15 of the movable frame 14, through the inlet zone 32 of the selecting device 3.

The pushing element 20 is fixed to a carriage 33, provided with wheels 34, suitable for sliding on a pair of sliding guides 35, that are parallel to one another, forming part of the support frame 21.

The carriage 33 is driven to slide on the sliding guides 35 by a first operating cylinder 22, which includes a body 36, fixed to the fixed frame 12 of the selecting device 3, and a stem 37, which is slidable inside the body 36 and is operationally connected to a first tie rod 39 and to a second tie rod 42.

An end 38 of the stem 37, a first end 40 of the first tie rod 39 and a first end 43 of the second tie rod 42 are hinged together.

A second end 41 of the first tie rod 39 is hinged on the fixed frame 12 of the selecting device 3.

A second end 44 of the second tie rod 42 is hinged on the carriage 33.

If the first operating cylinder 22 is so driven that the stem 37 retracts into the body 36, the carriage 33 is dragged along the sliding guides 35 to the inlet zone 32 of the selecting device 3, such that the pushing element 20 can push a piece of meat 10 onto a shelf 15 of the movable frame 14.

If on the other hand the first operating cylinder 22 is so driven that the stem 37 exits the body 36, the carriage 33 is pushed on the sliding guides 35 away from the inlet zone 32 of the selecting device 3.

On a second side 29 of the fixed frame 12, perpendicular to the first side 28, a second pushing element 25 is fixed that is driven by a second operating cylinder 26. The second pushing element 25 is used to expel the pieces of meat 10 from the selecting device 3.

On a third side 30 of the fixed frame 12, opposite the second side 29, a chute 23 is fixed that is arranged in a position opposite the second pushing element 25. The function of the chute 23 is to prevent or enable the expulsion of the pieces of meat 10 from the selecting device 3 and guide the pieces of meat 10 on the second conveyor 5, when the pieces of meat 10 are expelled from the selecting device 3.

The chute 23 is driven to move in vertical direction by a third operating cylinder 24 supported on the third side 30 of the fixed frame 12. The third operating cylinder 24 can move the chute 23 between a first position, which is visible in FIGS. 3 and 4, in which the chute 23 prevents the expulsion of a piece of meat 10, and a second position (not visible in the Figures), in which the chute 23 enables a piece of meat 10 to be expelled.

The drive of the motor 19, that drives the movements of the movable frame 14, the drive of the first pushing element 21, of the second pushing element 25 and of the chute 23, of the first conveyor 2, of the second conveyor 5, of the third conveyor 6, of the fourth conveyor 7 and of the fifth conveyor 8 are managed by a command and control device 47, for example a PLC, arranged, for example, in an electric panel 48 of the plant.

The command-and-control device 47 is further operationally associated with the measuring device 11.

The operation of the selecting device 3 is disclosed below.

When the length L of a piece of meat 10 is measured by the measuring device 11 of the press 1, the latter sends to the command-and-control device 47 a signal showing the length L of the piece of meat 10.

The command-and-control device 47 first verifies whether the length L of the piece of meat 10 is greater than a minimum set value L₀.

If the verification is negative, the command-and-control device 47 activates a visual or acoustic alarm signal to warn a plant operator O to reject the piece of meat 10.

If the verification is positive, the command-and-control device 47 enables forwarding of the piece of meat 10 to the selecting device 3 and stores the length of the piece of meat 10.

Starting from an initial situation, in which all the shelves 15 of the movable frame 14 are empty, a first piece of meat 10₁, having a length L₁, that reaches the selecting device 3, is arranged on a first shelf 15₁ and the position is stored by the command and control device 47, that then associates the piece of meat 10₁, having a length L₁, with the shelf 15₁.

The shelf 15₁ can be preset or be chosen at random by the command-and-control device 47.

When a second piece of meat 10₂ having a length L₂ is forwarded to the selecting device 3, the command-and-control device 47 verifies whether the difference between L₂ and L₁ is less than or the same as a preset amount ΔL.

If the verification is negative, the command-and-control device 47 arranges the further piece of meat 10₂ on a second empty shelf 15₂ and stores the position of the second piece of meat 10₂, thus associating the second piece of meat 10₂, having a length L₂, with the second shelf 152.

For each further piece of meat 10ₙ forwarded to the selecting device 3, the command-and-control device 47 verifies whether amongst the pieces of meat arranged on the shelves 15, a piece of meat 10ₖ exists whose length Lₖ differs from the length Lₙ of the piece of meat 10ₙ by an amount ≤ΔL.

If the verification is negative, the command-and-control device performs a further verification to ascertain whether there is an empty shelf 15ₙ in which to arrange the piece of meat 10ₙ.

If said empty shelf 15ₙ exists, when the piece of meat 10ₙ reaches the inlet zone 32 of the selecting device 3, the command and control device 47 moves the movable frame 14 until the empty shelf 15ₙ is taken to the level of the inlet zone 32 and activates the first operating cylinder 22 such that the first pushing element 20 can push the piece of meat 10ₙ onto the empty shelf 15ₙ.

If no empty shelf 15 exists on which the piece of meat 10ₙ can be arranged, the piece of meat 10ₙ is rejected and can be sent to a temporary storage station for possible subsequent repeated forwarding to the selecting device 3.

If on the other hand the presence is detected on a shelf 15ₖ of a piece of meat 10ₖ, whose length Lₖ differs from the length Ln of the piece of meat 10n by an amount SAL, the command and control device 47 moves the movable frame 14, until the shelf 15ₖ, containing the piece of meat 10ₖ, is taken to the level of the second pushing element 25, then activates the third operating cylinder 24 to take the chute 23 to its second position in which it enables the piece of meat 10ₖ to be expelled from the shelf 15ₖ of the movable frame 14.

Subsequently, the command-and-control device 47 activates the second operating cylinder 26 that drives the second pushing element 25 such that the piece of meat 10ₖ placed on the shelf 15ₖ is pushed outside the shelf 15ₖ onto the chute 23, which guides the piece of meat 10ₖ onto the second conveyor 5.

Subsequently, the command and control device 47 drives a further movement of the movable frame 14 until the now empty shelf 15ₖ is taken to the level of the inlet zone 32 of the selecting device 3 and activates the first operating cylinder 22 so as to drive the first pushing element 20, which pushes the piece of meat 10ₙ onto the shelf 15ₖ.

Lastly, the command and control device 47 drives a still further movement of the movable frame 14 to return the shelf 15ₖ to the level of the second pushing element 25, and again moves the second operating cylinder 26 to push the piece of meat 10ₙ onto the chute 23 and onto the second conveyor device 5, where the piece of meat 10ₖ was previously transferred so as to form a group G of pieces of meat 10 consisting of two pieces of meat 10 whose lengths differ by an amount ≤ΔL.

The operations disclosed above can be repeated until on the conveyor device 5 a group G of pieces of meat 10 is formed including a set number of pieces of meat 10, which is greater than two and depends on the features of the slicing machine 9, in which the difference in length between any two pieces of meat 10 of the group G is ≤ΔL.

The second conveyor device 5 is then driven that conveys the group G of pieces of meat 10 through the cooling tunnel 4 as far as the third conveyor 6, on which the pieces of meat 10 of the group G are arranged behind one another and conveyed to the fourth conveyor 7, which receives a first piece of meat 10 and transfers the first piece of meat 10 to the fifth conveyor 8, then receives a second piece of meat 10, moves laterally on the guides 45, for example to the left in FIG. 1, and transfers the second piece of meat 10 to the fifth conveyor 8, alongside the first piece of meat 10 and so on until on the fifth conveyor 8 the group G of pieces of meat 10 is reconstituted with the pieces of meat 10 arranged alongside one another.

Lastly, the fifth conveyor 8 rotates by 90° around the rotation axis A and conveys the group G of pieces of meat 10 to the slicing machine 9, which slices the pieces of meat 10.

As the difference in length between any two pieces of meat 10 of the group G is ≤ΔL, at the end of the slicing operation, waste remains consisting of portions of pieces of meat of a length ≤ΔL.

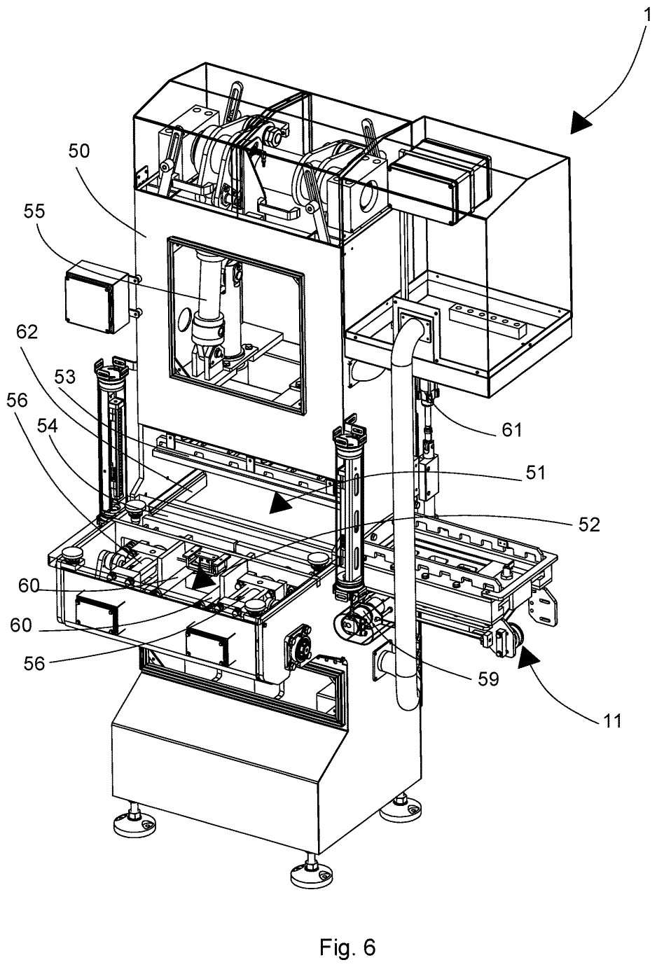

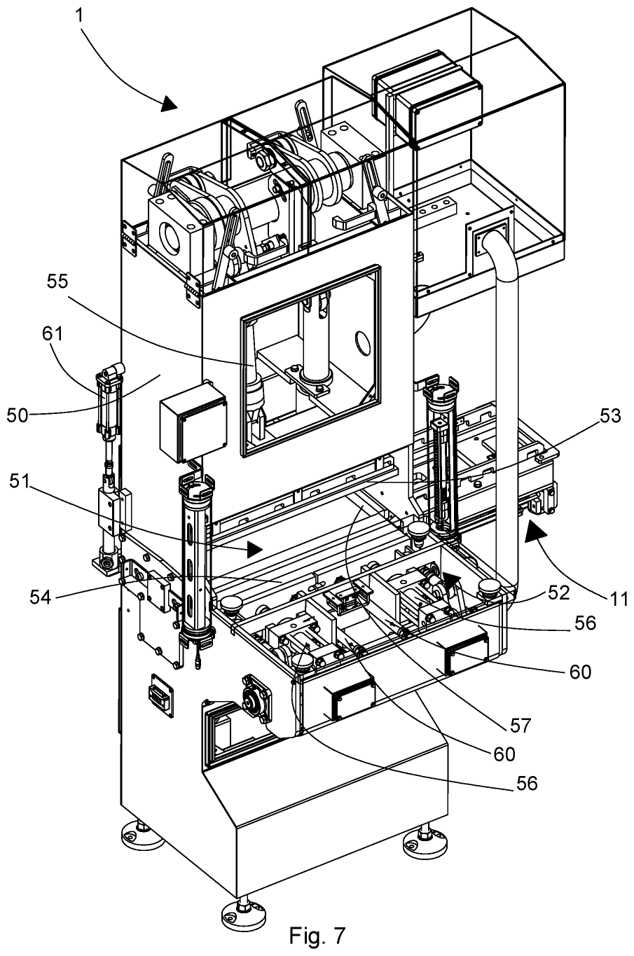

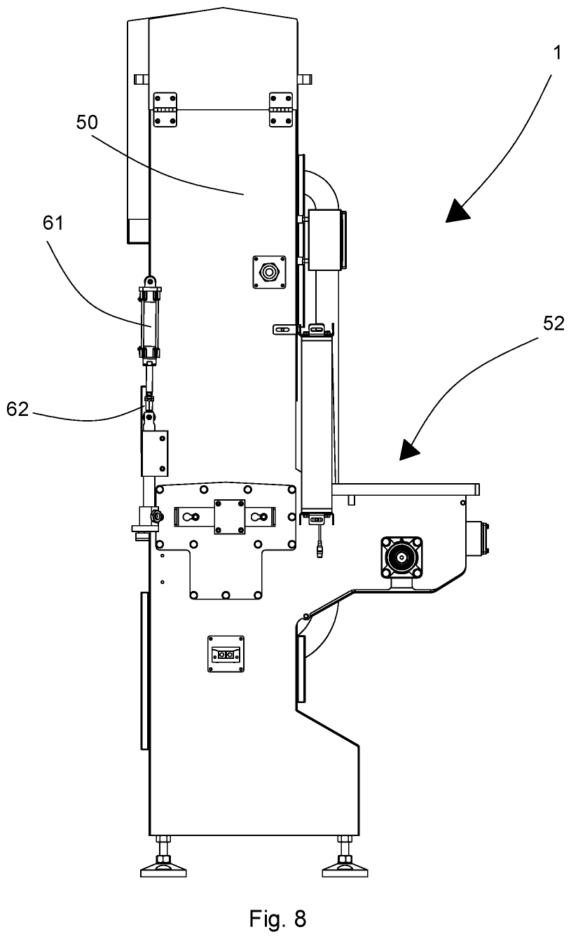

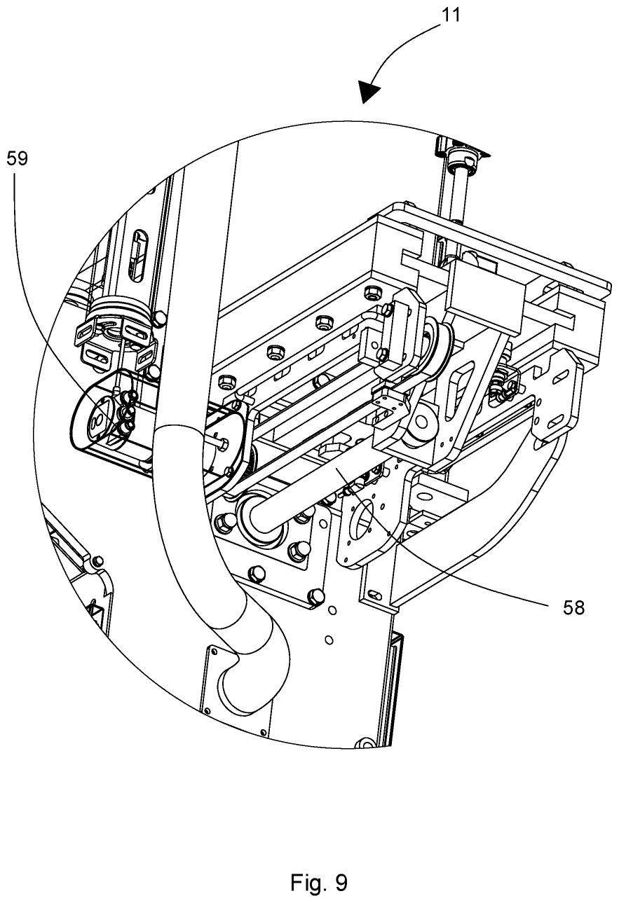

In FIGS. 6 to 9, the press 1 according to the invention is illustrated, which includes a press body 50, inside which a pressing zone 51 is obtained, inside which the pieces of meat 10 to be shaped and measured are inserted through an inlet zone 52 and are arranged with a first side in contact with an abutting element 62.

The press 1 is provided with a first pressing element 53, by means of which a height is adjusted of the piece of meat entered into the press 1, and with a second pressing element 54, by means of which a width of the piece of meat 10 is adjusted.

The first pressing element 53 is driven by a first operating cylinder 55, which moves the first pressing element 53 in a vertical direction, i.e. parallel to the direction of the force of gravity.

The second pressing element 54 is driven by a first pair of operating cylinders 56 that move the second pressing element 54 in a first horizontal direction, i.e. perpendicular to the direction of the force of gravity.

The press 1 is further equipped with a measuring device 11 by which the length of a piece of meat 10 is measured.

The measuring device 11 includes a third pressing element 57, driven by at least one second operating cylinder 58.

After a piece of meat 10 has been inserted into the pressing zone 51 and pressed by the first pressing element 53 and by the second pressing element 54, the third pressing element 57 is driven by the at least one second operating cylinder 58, which moves the third pressing element 57 in a second horizontal direction, perpendicular to the first horizontal direction, until it comes into contact with a second side of the piece of meat 10, opposite the first side in contact with the abutting element 62.

When the third pressing element 57 comes into contact with the piece of meat 10, an encoder 59, operationally associated with the third pressing element 57, detects the contact made with the piece of meat 10 and sends a signal to the PLC 47, which stops the at least one operating cylinder 58.

The encoder 59, associated with the third pressing element 57, measures the displacement S of the latter between an initial reference position placed at a distance D from the abutting element 62 and the position in which the third pressing element comes into contact with the piece of meat 10.

The length L of the piece of meat 10 is equal to the difference between D and S, i.e. L=D−S.

After the length of the piece of meat 10 has been measured, a second pair of operating cylinders 61 is activated that open a bulkhead 62, to enable the piece of meat 10 to be expelled from the pressing zone 51 and be transferred to the first conveyor 2.

The expulsion of the piece of meat 10 from the pressing zone 51 is obtained by moving in said first horizontal direction the second pressing element 54 by a third pair of operating cylinders 60, until the piece of meat 10 is pushed onto the first conveyor 2.

1. A selecting usable in a plant for slicing pieces of meat for selecting from a plurality of pieces of meat groups of pieces of meat, in which lengths of any two pieces of meat of a group differ by an amount that is not greater than a set amount ΔL, wherein it includes:
a fixed frame that extends in a vertical direction,
a movable frame that can slide inside the fixed frame in the vertical direction, wherein said the movable frame is provided with a plurality of shelves each of which is designed to receive a piece of meat meat,
a first pushing element that can slide on a support frame fixed to a first side of the fixed frame, at an inlet zone of the selecting device, the first pushing element being designed to push on a shelf of the movable frame a piece of meat conveyed by a first conveying device, wherein a second pushing element is fixed to a second side of the fixed frame, perpendicular to the first said, the second pushing element being designed to push a piece of meat, placed on a shelf of the movable frame, outside the shelf,
a command and control device operationally associated with a measuring device configured to measure a length of said the pieces of meat,
wherein the command and control device is configured to store the length of the pieces of meat, to store the position of a piece of meat in the movable frame, when the piece of meat is placed on a shelf of the movable frame, to drive the movable frame, the first pushing element and the second pushing element on the basis of signals received from the measuring device and on data on the position of the pieces of meat in the movable frame stored by the command and control device.

2. The selecting device according to claim 1, wherein the movable frame is connected to a slide, that can slide in the vertical direction, along a sliding guide, fixed to a base of the selecting device, wherein the slide is driven by a motor motor via transmission.

3. The selecting device according to claim 1, wherein the pushing element is fixed to a carriage that is slidable on a pair of sliding guides, that are parallel to one another, forming part of the support frame.

4. The selecting device according to claim 3, in which the carriage is driven to slide on the sliding guides by a first operating cylinder, which includes a body, fixed to the fixed frame, and stem, which is slidable inside the body and is operationally connected to a first tie rod and a second tie rod, in which an end of the stem, a first end of the first tie rod and a first end of the second tie rod are hinged together, in which a second end of the first tie rod is hinged on the fixed frame and a second end of the second tie rod is hinged on the carriage.

5. The selecting device according to claim 1, wherein a second pushing element, driven by a second operating cylinder is fixed to the second side of the fixed frame.

6. The selecting device according to claim 1, wherein it further includes a chute designed to guide the pieces of meat on the second conveyer, when the pieces of meat are expelled from the selecting device, wherein the chute is supported on a third side of the movable frame, opposite the second side, so as to be able to move between a first position, in which the chute prevents a piece of meat from being expelled from a shelf of the movable frame, and a second position, in which the chute enables the piece of meat to be expelled from the shelf, wherein the chute is driven by a third operating cylinder supported on said third side.

7. The selecting device according to claim 6, wherein the command-and-control device is configured to drive the motor, the first operating cylinder, the second operating cylinder, the third operating cylinder and to activate a visual or acoustic alarm signal.

8. A method for selecting from a plurality of pieces of meat groups of pieces of meat to be sent to a slicing machine to be sliced, wherein it includes the following steps:
pressing the pieces of meat in a press so as to give the pieces of meat a substantially rectangular plan shape with a substantially constant width and thickness;
measuring a length L of each of the pieces of meat;
forming groups of pieces of meat consisting of a number of pieces of meat greater than or the same as two, such that lengths L of any two pieces of meat of group differ from one another by an amount ≤ΔL, wherein ΔL is a set interval of length;
sending the groups of pieces of meat to the slicing machine.

9. The method according to claim 8, further including setting a minimum reference length Lo for the pieces of meat and rejecting a piece of meat if the length L thereof is less than the minimum reference length L₀.

10. A method for selecting from a plurality of pieces of meat groups of pieces of meat to be sent to a slicing machine to be sliced, wherein it includes the following steps:
pressing the pieces of meat in a press so as to give the pieces of meat a substantially rectangular plan shape with a substantially constant width and thickness;
measuring a length L of each of the pieces of meat;
forming groups of pieces of meat consisting of a number of pieces of meat greater than or the same as two, such that lengths L of any two pieces of meat of a group differ from one another by an amount ≤ΔL, wherein ΔL is a set interval of length;
sending the groups of pieces of meat to the slicing machine.
wherein the forming occurs by using a selecting device according to claim 1.

11. The method according to claim 10, further including arranging in the selecting device a plurality of pieces of meat, pressed in the press, wherein a single piece of meat is arranged on each shelf.

12. The method according to claim 11, further including sending a piece of meat pressed in the press, to the selecting device, coupling the piece of meat with another piece of meat, present in the selecting device, the length Lₖ of which differs from the length Ln of the piece of meat by an amount ≤ΔL.

13. The method according to claim 8, further including sending the groups of pieces of meat through a cooling tunnel and, subsequently, to a slicing machine.

14. A plant for slicing pieces of meat wherein it includes:
a press configured to press the pieces of meat so as to give the pieces of meat a substantially rectangular plan shape with a substantially constant width and thickness, wherein the press includes a measuring device configured to measure a length of the piece of meat;
a selecting device according to claim 1, configured to form groups of pieces of meat in which lengths of any two pieces of meat of a group differ by an amount ≤ΔL, wherein ΔL is a set interval of length;
a command and control device configured to drive said selecting device;
a cooling tunnel for cooling the pieces of meat;
a slicing machine.

15. The plant according to claim 14, wherein it further includes:
a first conveyor that conveys the pieces of meat from the press to the selecting device;
a second conveyor that conveys pairs of pieces of meat from the selecting device to the cooling tunnel and through the cooling tunnel;
a further conveyor that conveys the pairs of pieces of meat from the cooling tunnel to the slicing machine.

16. The plant according to claim 15, wherein said further conveyor includes a third conveyor, a fourth conveyor, and a fifth conveyor.

17. The plant according to claim 16, wherein the fourth conveyor is movable transversely, in a direction perpendicular to an advancement )direction of the pieces of meat on the fourth conveyor.

18. The plant according to claim 17, wherein the fifth conveyor is configured to rotate around a rotation axis, perpendicular to a conveying plane of the fifth conveyor.

19. The plant according to claim 15, further including a measuring device associated with said the first conveyor, the measuring device being configured to measure a length L of the pieces of meat.

20. The plant according to claim 14, wherein the command and control device is operationally associated with said the selecting device, with said the measuring device, with the first conveyor, with said the second conveyor, with the third conveyor 6, with the fourth conveyor, with the fifth conveyor.

21. A press for a plant for slicing pieces of meat meat including a pressing zone designed to receive a piece of meat to be pressed, a first pressing element, movable in a vertical direction, by means of which a height of the piece of meat inserted into the pressing zone is adjusted, a second pressing element movable in a first horizontal direction, by means of which a width of the piece of meat is adjusted, wherein it includes a measuring device configured to measure a length of the piece of meat, wherein the measuring device includes an abutting element placed in said the pressing zone, a third pressing element which is movable in a second horizontal direction, perpendicular to the first horizontal direction, and an encoder, operationally associated with the third pressing element.

22. The press according to claim 21, wherein encoder is configured to detect a contact between the third pressing element and the piece of meat.

23. The press according to claim 21, wherein the encoder is configured to measure a displacement of the third pressing element between a reference position placed at a distance from said the abutting element and a contact position, in which the third pressing element comes into contact with the piece of meat.
